(19) United States
(12) Patent Application Publication
(10) Pub. No.: US 2008/0019131 A1
(43) Pub. Date: Jan. 24, 2008

(54) Lighting systems and methods

(76) Inventors: Yoshiharu Takei, Diamond Bar, CA (US); Ajmal Shaker, Murrieta, CA (US)

Correspondence Address: Ajmal Shaker, Suite B, 42188 Rio Nedo, Temecula, CA, 92590, US

(21) Appl. No.: 11/491,689

(22) Filed: Jul. 24, 2006

(51) Int. Cl. F21V 33/00

(52) U.S. Cl. 362/253

(57) ABSTRACT

An embodiment of a lighting system includes: a base component; a light emitting component that is attached to said base component; a finger interface component that is configured to be attached to said base component and to a user's finger; wherein said light emitting component is configured to rotate relative to said base component while remaining attached to said base component; and wherein said light emitting component is also configured to rotate relative to a portion of said user's finger while said finger interface component is attached to said base component and said portion of said user's finger.

### BACKGROUND

Existing portable lighting systems enable a user to shine a light on a desired area by holding a lighting system while pointing it in the desired direction. However, these lighting systems require a user to grasp them during use, thereby preventing full use of the user's hands during operation of the lighting systems. Therefore there exists a need for systems and methods that address these and/or problems associated with existing portable lighting systems.

### SUMMARY

Systems and methods for a lighting system are provided. An embodiment of a lighting system includes: a base component; a light emitting component that is attached to said base component; a finger interface component that is configured to be attached to said base component and to a user's finger; wherein said light emitting component is configured to rotate relative to said base component while remaining attached to said base component; and wherein said light emitting component is also configured to rotate relative to a portion of said user's finger while said finger interface component is attached to said base component and said portion of said user's finger.

A method for using a lighting system includes: attaching a base component to a user's finger; wherein said base component is attached to a light emitting component; and rotating said light emitting component relative to said base component while said light emitting component remains attached to said base component.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIGS. 1A and 1B are schematic diagrams depicting an embodiment of a light system.

FIGS. 2A and 2B are schematic diagrams depicting respective embodiments of a light system that include means for attaching the light system to a band or strap.

FIGS. 2C-2E are schematic diagrams depicting respective embodiments of a light system that comprises means for attaching the light system to a user's finger.

FIGS. 3A and 3B are a circuit diagrams according to embodiments of the invention.

FIGS. 4A-4D are schematic diagrams depicting respective views of a base according to an embodiment of the invention.

FIGS. 5A and 5B are schematic diagrams depicting respective views of a light projector according to an embodiment of the invention.

FIGS. 6A and 6B are schematic diagrams depicting an embodiment of a light system being assembled.

FIG. 7 is a flow chart depicting a method according to an embodiment of the invention.

### DETAILED DESCRIPTION OF THE PREFERRED EMBODIMENTS

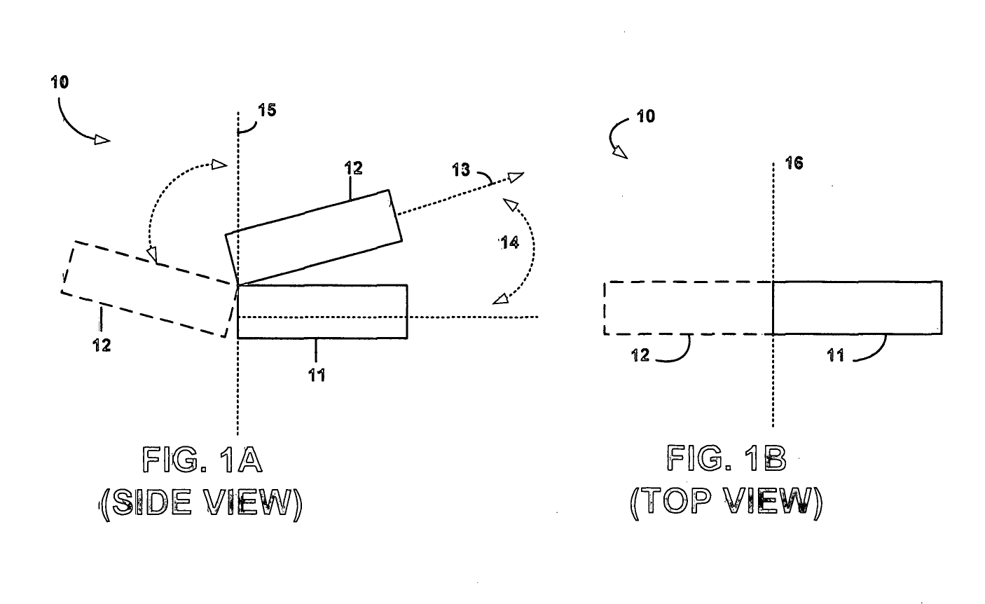

FIGS. 1A and 1B are schematic diagrams depicting an embodiment of a light system 10. The light system 10 includes a base 11 and a light projector 12. The light projector 12 includes a light emitter (not shown) that emits light waves 13. The light projector 12 is attached to the base 11 via means that enable the light projector 12 to rotate while the base 11 remains stationary. For example the light projector 12 may be rotated such that angle 14 between the base 11 and the light projector 12 is varied. The light system 10 may also be configured such that the light projector 12 can rotate around the axis 16. The light projector 12 may be attached to the base 11 via a hinge-like joint or a ball and socket-like joint, among others.

Examples of materials that may be used for the exterior of the light projector 12 and/or for the base 11 include, for example, among others:
PVC (transparent, translucent, or opaque) (painted or non-painted)
Chrome
Aluminum
Rubber

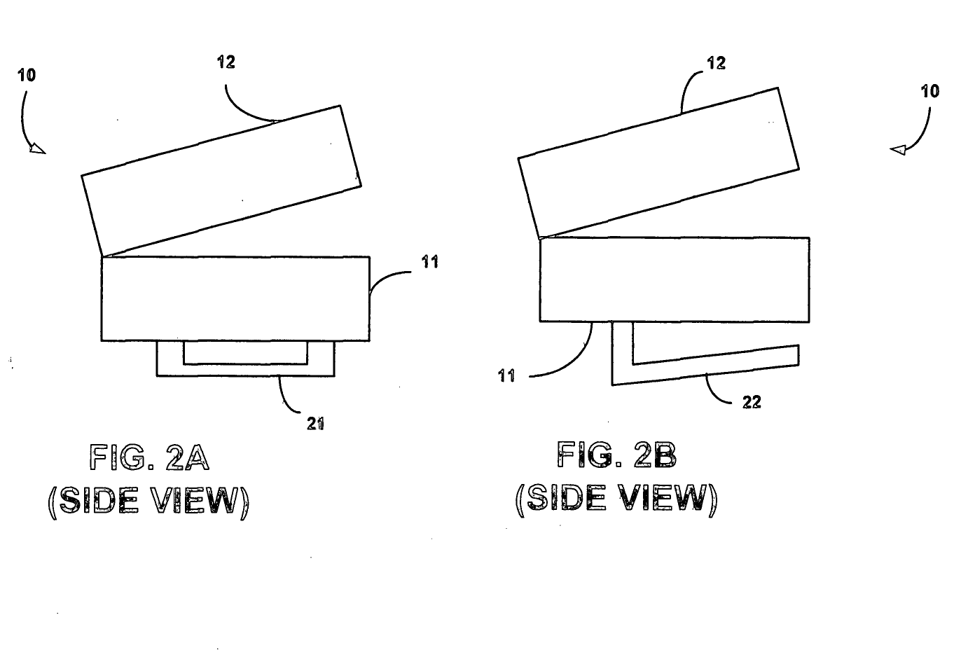

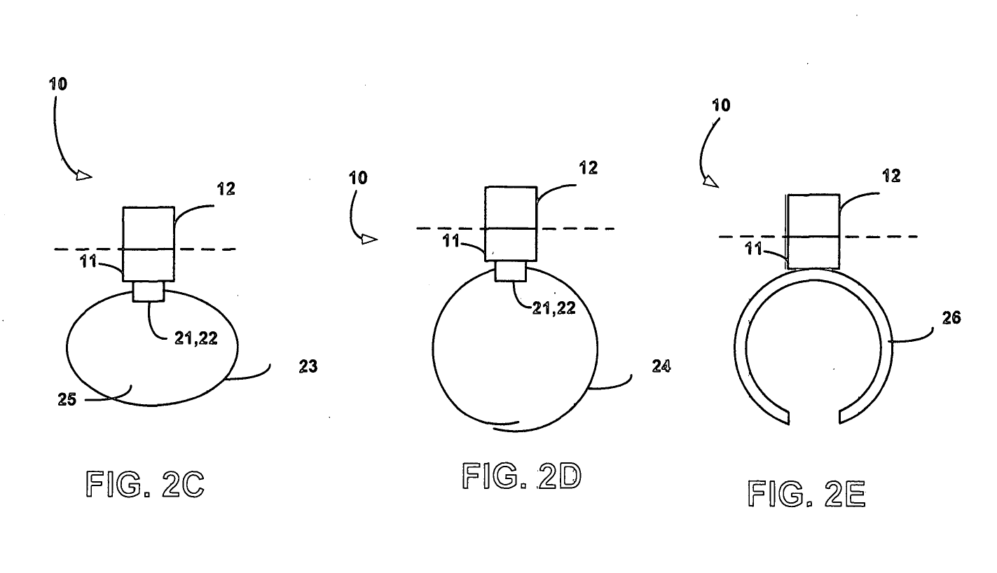

FIGS. 2A and 2B are schematic diagrams depicting respective embodiments of a light system 10 that include means for attaching the light system 10 to a band or strap. The light system 10 is configured to be attached to a user's finger (e.g. via a band or a strap). The light system 10 may include a loop 21 (FIG. 2A) or a clip 22 (FIG. 2B) that may be attached to a band (FIG. 2C) or a strap (FIG. 2D). The band or strap may comprise, for example, elastic and/or rubber. The strap may be secured to a finger via, for example, Velcro. The light system 10 may include another loop (e.g., that may be attached to or part of the light projector 12) to enable the light system 10 to be suspended by a string or rope that goes through such other loop (e.g., the string or rope may hang around a user's neck).

FIGS. 2C-2E are schematic diagrams depicting respective embodiments of a light system 10 that comprises means for attaching the light system 10 to a user's finger. As shown in FIG. 2C, the light system 10 includes a band 23. A user may attach the light system 10 to his/her finger by inserting the finger into an opening 25 defined by the band 23. As shown in FIG. 2D, the light system 10 includes a strap 24. A user may attach the light system 10 to his/her finger by strapping the strap 24 around her/her finger. The band 23 and the strap 24 may either be slidably removable from the base 11 or may be more securely attached (e.g., bonded or tightly fastened). The band 23 and/or the strap 24 may each comprise, for example, one or more of the following materials, among others:
rubber
metal
plastic
leather

### As shown in FIG. 2E, The base 11 may alternatively be attached to a user's finger via a clip 26, which may comprise, for example, metal or plastic, among other materials, depending on a desired implementation.

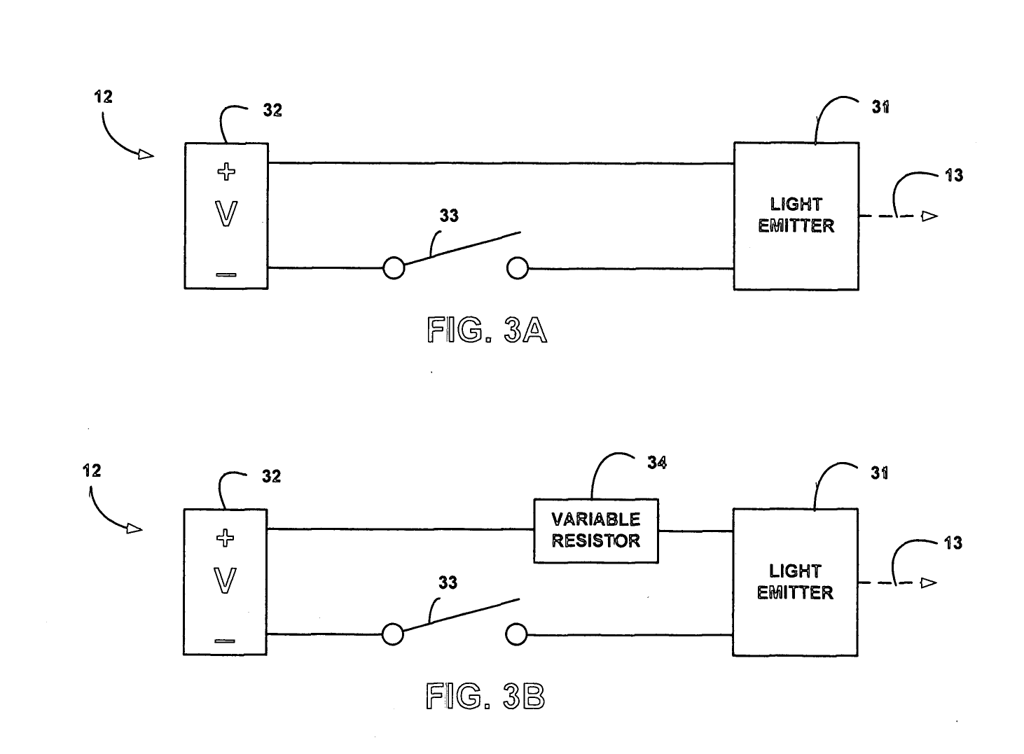

FIG. 3A is a circuit diagram according to an embodiment of the invention. As shown in FIG. 3, the light projector 12 includes a light emitter 31, a voltage source 32, and a switch 33. The voltage source 32 is coupled to the light emitter 31 and enables the light emitter 31 to output light waves 13. A switch 33 controls the current flow between the voltage source 32 and the light emitter 31. The switch 33 may be activated by a button or rotating knob (not shown) that is located (at least in part) on the exterior of the light projector 12. As shown in FIG. 3B, the light projector 12 may also include a variable resistor 34 that can be used to adjust the brightness of the light being emitted by the light emitter 31.

Note that the light emitter may emit one or more colors and may comprise, for example:
a laser emitter
a halogen light emitter
a xenon light emitter
an ultraviolet light emitter
an infrared light emitter
an LED (light emitting diode)

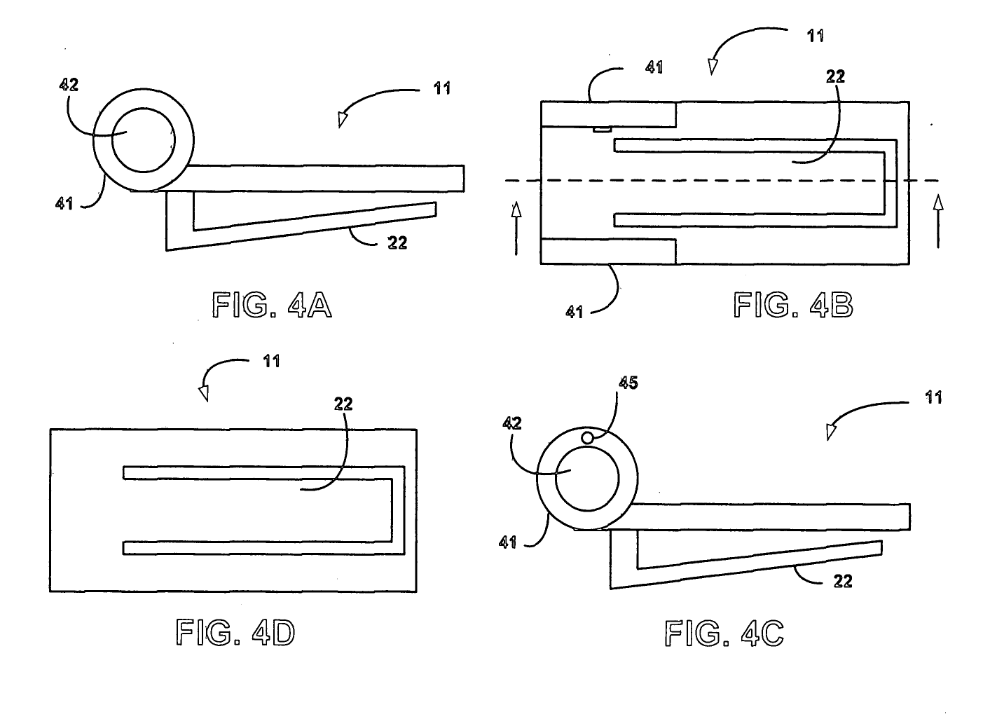

FIGS. 4A-4D are schematic diagrams depicting respective views of a base 11 according to an embodiment of the invention. As shown in FIGS. 4A-4D, the base 11 includes two rings 41 which have respective openings 42. The base 11 also includes a clip 22, which enables the base 11 to be attached to a band or a strap (which may then be attached to a user's finger).

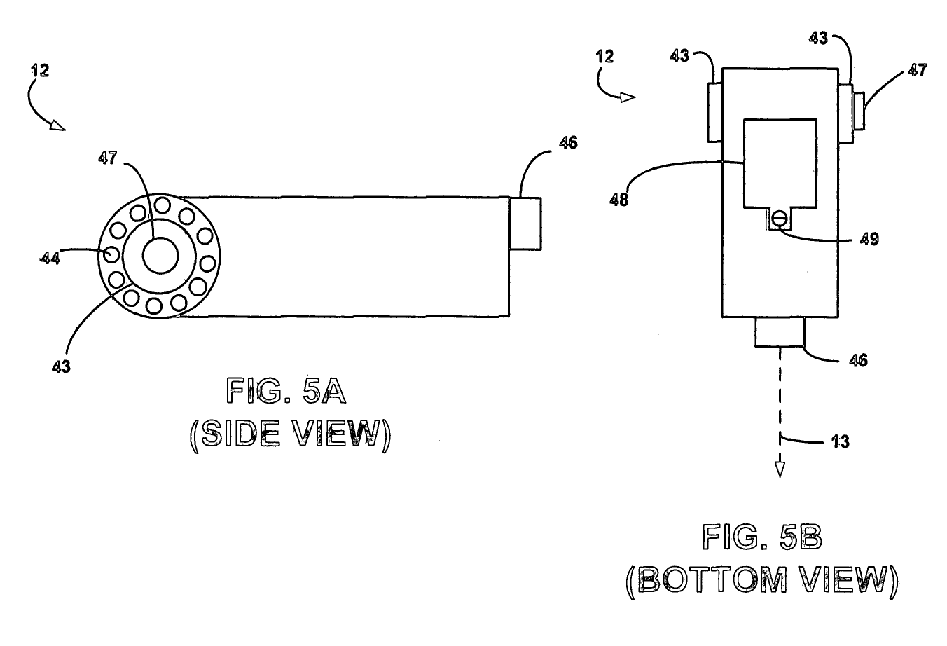

FIGS. 5A and 5B are schematic diagrams depicting respective views of a light projector 12 according to an embodiment of the invention. As shown in FIGS. 5A and 5B, The light projector 12 includes two rims 43. Each rim 43 is configured to fit inside a respective opening 42 (FIGS. 4A-4D) to enable the light projector 12 to rotate relative to the base 11 (FIGS. 4A-4D). The light projector 12 includes holes 44 located around each rim 43. The ring 41 (FIGS. 4A-4D) includes a protrusion 45 that is configured to fit (at least partially) inside each of the holes 44. As the light projector 12 rotates, the protrusion 45 moves from one hole 44 to another hole 44. The hole 44 and the protrusion 45 prevent the light projector 12 from rotating unless sufficient force is exerted on the light projector 12 (e.g., to prevent unwanted rotation).

In one embodiment, an on/off button 47 extends through the rim 43. The on/off button 47 enables the light emitter 31 (FIG. 3) to be activated and de-activated. Note that the on/off button 47 may be located at various positions (e.g., top, bottom, front, rear, left side, or right side) on the light emitter 12 or the base 11. The on/off button 47 may alternatively be replaced with rotating knob that activates or de-activates the light emitter 31 responsive to the knob being rotated. Furthermore, the on/off button 47 may also function as a rotating knob that varies the intensity of the light being emitted by the light projector 12 (e.g., by twisting the on/off button 47) responsive to rotational force being applied to the on/off button 47.

The light projector 12 includes a battery cover 48 which is secured via a screw 49 (optional). The battery cover 48 may be removed in order to replace a battery (not shown) within the light projector 12. Note that the battery cover 48 may be at a different location, depending on a desired implementation.

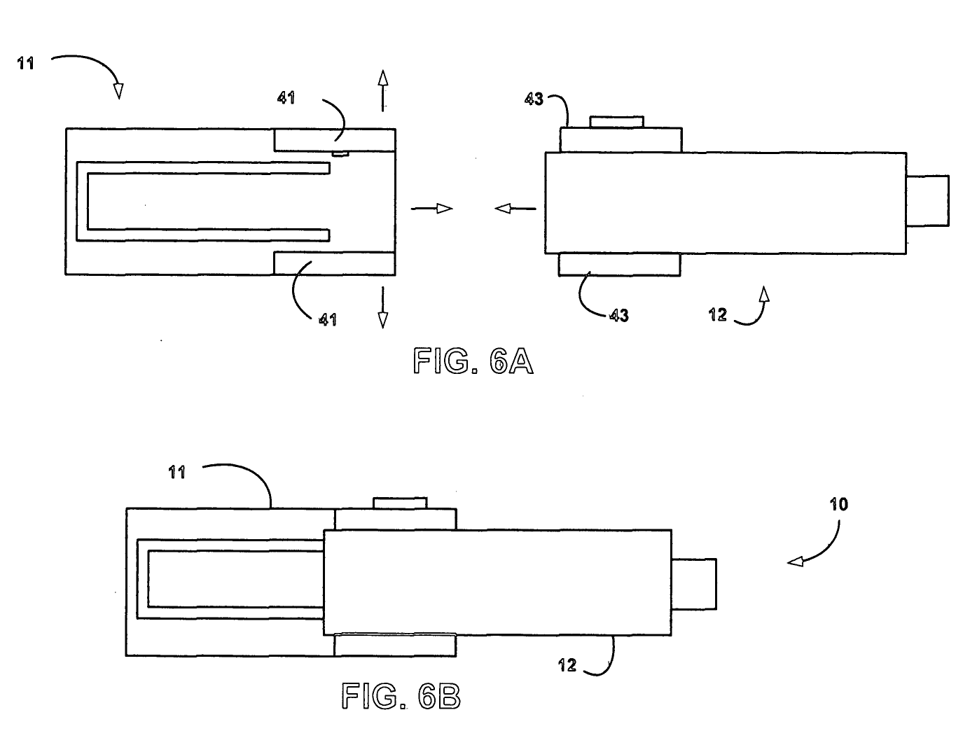

FIGS. 6A-6D are schematic diagrams depicting an embodiment of a light system 10 being assembled. As shown in FIGS. 6A-6D, the light projector 12 may be attached to the base 11 by inserting each rim 43 is within an opening 42 (FIGS. 4A-4D) of a respective ring 41. In this manner, the light projector 12 is configured to rotate relative to the base 11. The rings 41 may be pulled apart to enable the rims 43 to fit between the rings 41.

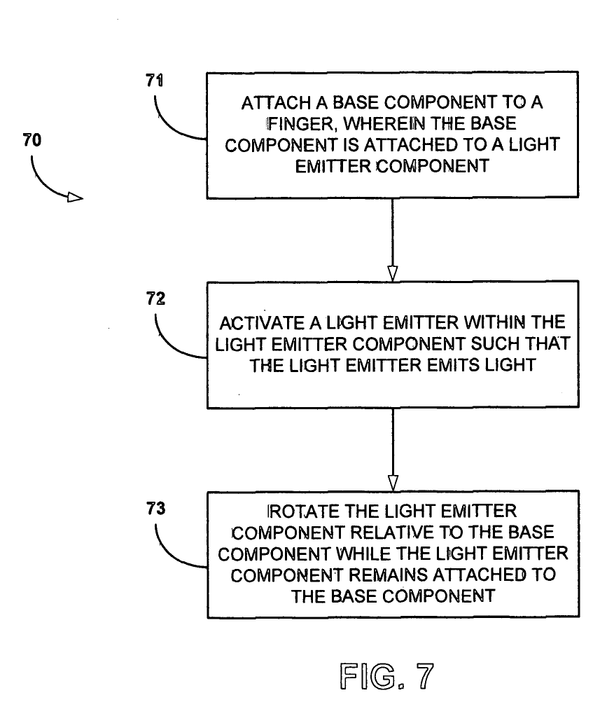

FIG. 7 is a flow chart depicting a method 70 according to an embodiment of the invention. The method 70 includes attaching a base component to a finger, wherein the base component is attached to a light emitter component (step 71); activating a light emitter within the light emitter component such that the light emitter emits light (step 72); and rotating the light emitter component relative to the base component while the light emitter component remains attached to the base component (step 73).

It should be emphasized that the above-described embodiments of the present invention are merely possible examples, among others, of the implementations, setting forth a clear understanding of the principles of the invention. Many variations and modifications may be made to the above-described embodiments of the invention without departing substantially from the principles of the invention. All such modifications and variations are intended to be included herein within the scope of the disclosure and present invention.

1. A lighting system comprising:
a base component;
a light emitting component that is attached to said base component;
a finger interface component that is configured to be attached to said base component and to a user's finger;
wherein said light emitting component is configured to rotate relative to said base component while remaining attached to said base component; and
wherein said light emitting component is also configured to rotate relative to a portion of said user's finger while said finger interface component is attached to said base component and said portion of said user's finger.

2. The lighting system of claim 1, wherein:
said base component comprises at least one of PVC, chrome, aluminum, and rubber.

3. The lighting system of claim 1, wherein:
said light emitting component comprises at least one of PVC, chrome, aluminum, and rubber.

4. The lighting system of claim 1, wherein:
said light emitting component comprises a light emitter configured to emit light; and
wherein said light emitter comprises at least one of a laser emitter, a halogen light emitter, a xenon light emitter, an ultraviolet light emitter, an infrared light emitter, and a light-emitting diode (LED).

5. The lighting system of claim 4, wherein:
said lighting system comprises a battery configured to power said light emitter.

6. The lighting system of claim 1, wherein:
said finger interface component comprises a band configured to be attached to said user's finger; and
wherein said band comprises at least one of rubber, metal, plastic, and leather.

7. The lighting system of claim 1, wherein:
said finger interface component comprises a strap configured to be attached to said user's finger; and
wherein said strap comprises at least one of cotton, polyester, rubber, metal, plastic, and leather.

8. The lighting system of claim 1, wherein:
said finger interface component comprises a clip configured to be attached to said user's finger; and
wherein said clip comprises at least one of metal and plastic.

9. A method for using a lighting system, said method comprising:
attaching a base component to a user's finger, wherein said base component is attached to a light emitting component; and
rotating said light emitting component relative to said base component while said light emitting component remains attached to said base component.

10. The method of claim 9, further comprising:
activating a light emitter within said light emitting component such that said light emitter emits light.

11. The method of claim 9, wherein said lighting system comprises:
a base component;
a light emitting component that is attached to said base component;
a finger interface component that is configured to be attached to said base component and to a user's finger;
wherein said light emitting component is configured to rotate relative to said base component while remaining attached to said base component; and
wherein said light emitting component is also configured to rotate relative to a portion of said user's finger while said finger interface component is attached to said base component and said portion of said user's finger.

12. The method of claim 9, wherein said base component comprises at least one of PVC, chrome, aluminum, and rubber.

13. The method of claim 9, wherein said light emitting component comprises at least one of PVC, chrome, aluminum, and rubber.

14. The method of claim 9, wherein:
said light emitting component comprises a light emitter configured to emit light; and
wherein said light emitter comprises at least one of a laser emitter, a halogen light emitter, a xenon light emitter, an ultraviolet light emitter, an infrared light emitter, and a light-emitting diode (LED).

15. The method of claim 9, wherein said lighting system comprises a battery configured to power said light emitter.

16. The method of claim 9, wherein:
said finger interface component comprises a band configured to be attached to said user's finger; and
wherein said band comprises at least one of rubber, metal, plastic, and leather.

17. The method of claim 9, wherein:
said finger interface component comprises a strap configured to be attached to said user's finger; and
wherein said strap comprises at least one of cotton, polyester, rubber, metal, plastic, and leather.

18. The method of claim 9, wherein:
said finger interface component comprises a clip configured to be attached to said user's finger; and
wherein said clip comprises at least one of metal and plastic.
